(19) United States
(12) Patent Application Publication
(10) Pub. No.: US 2013/0134137 A1
(43) Pub. Date: May 30, 2013

(54) Universal Stake Adapter

(71) Applicant: Glen Stuhlmacher, San Ramon, CA (US)

(72) Inventor: Glen Stuhlmacher, San Ramon, CA (US)

(21) Appl. No.: 13/306,978

(22) Filed: Nov. 29, 2011

(51) Int. Cl. B23K 11/30

(52) U.S. Cl. 219/119

(57) ABSTRACT

A Universal Stake Adapter for a Dent Repair Stud Welder that provides an economical alternative for holding and heating a stake required during thermoplastic repair operations.

### BACKGROUND OF THE INVENTION

1. Field of the Invention

This invention relates to an Universal Stake Adapter for a Dent Repair Stud Welder commonly used during auto repair operations.

2. Prior Art

Thermoplastic materials are used in any of wide variety automotive applications. Thermoplastic Automotive parts such as fenders, bumpers, mirrors, etc. are frequently damaged by an automotive collision. This damage includes rips, tears, fractures and or holes in the thermoplastic material. Numerous devices to assist in the repair thermoplastic material include; Adhesives, hot air welding, melting with a hot iron.

Hot stapling thermoplastic material is the preferred method but requires purchasing an expensive device such as the Dent Fix brand part no. DF-800BR or Punto Plast brand hot stapler part no. 6201. These devices are specific and have a limited use. With the average price of approximately $500 it is hard to justify the expense.

### SUMMARY OF THE INVENTION

The present invention provides an economical alternative for holding and supporting a stake during thermoplastic repair operations which overcomes the problems noted above. The present invention makes use of a common Stud Welder such as Motor Guard brand Magna-Spot® 1500 part no. JO-1500 used in automotive repairs, by converting the Stud Welder in to a Hot Stake Stitcher.

The present invention comprises an adapter which includes an outer electric power transfer electrode capable of connecting to the outer power head electrode of a stud welder and a inner electric power transfer electrode capable of connecting to the stud welder's inner electrode. The outer electrode of the universal stake adapter is connected to one of stake retaining electrodes and the inner electrode of the universal stake adapter is connected to the remaining stake retaining electrode. Each of the stake retaining electrodes includes a bore located at end to removably receive one of terminals of a stake, converting the stud welder into a hot stapler. A thumbscrew is used to insure a secure connection between the stud welder and the universal stake adapter.

These and other objects, advantages and embodiments will become more apparent when reviewed with the accompanying figures and detailed description.

### BRIEF DESCRIPTION OF THE DRAWINGS

FIG. 1 is a cross sectional view of the power head of the stud welder and the universal stake adapter assembly.

FIG. 2 is a cross sectional assembled view of the power head of the stud welder and the universal stake adapter assembly.

FIG. 3 is a cross sectional view of the universal stake adapter's stake retaining electrodes.

FIG. 4 is a cross sectional view of the damaged thermoplastic material repair process;

FIG. 5 is an exploded assembly view of the new universal stake thermoplastic repair tool.

### DETAILED DESCRIPTION OF THE INVENTION

Referring to the accompanying drawing, in which like reference numerals refer to like parts, FIG. 1 is a cross sectional view of the power head of the stud welder 101 and the universal stake adapter assembly 104. The power head of the stud welder 101 is shown which has an outer electrode 102 and inner electrode 103. The universal stake adapter assembly 104 is shown which has an outer electrode 106 which is capable of contacting the outer electrode the stud welder's outer electrode 102 and inner electrode 107 which is capable of contacting the outer electrode the stud welder's inner electrode 103. A thumb screw 105 is capable of locking the universal stake adapter assembly 104 to the power head of the stud welder 101 by moving the universal stake adapter outer electrode 106 into the stud welder's outer electrode 102.

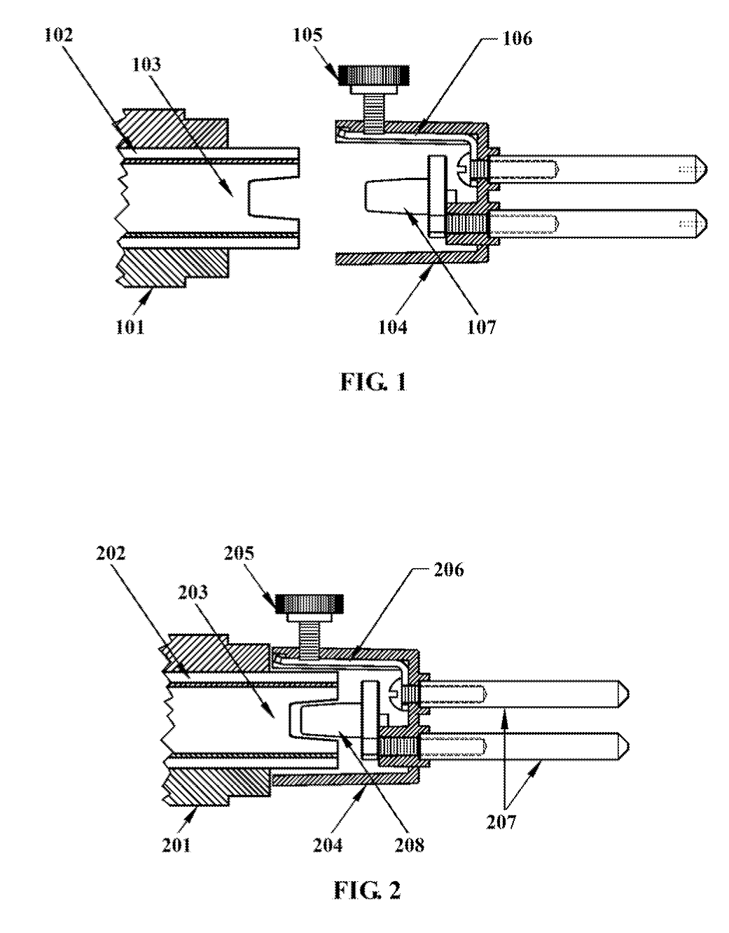

FIG. 2 is a cross sectional assembled view of the power head of the stud welder 201 and the universal stake adapter assembly 204. The universal stake adapter 204 is affixed to the stud welder 201 by tightening the thumb screw 205 into outer electrode 206 locking it agents the stud welder's outer electrode 202. Any electrical current from the stud welder's outer electrode 202 is now conducted through the universal stake adapter's outer electrode 206 then through one of the stake retaining electrodes 207. Any electrical current from the stud welder's inner electrode 203 is now conducted through the universal stake adapter's inner electrode 208 then through one of the stake retaining electrodes 207.

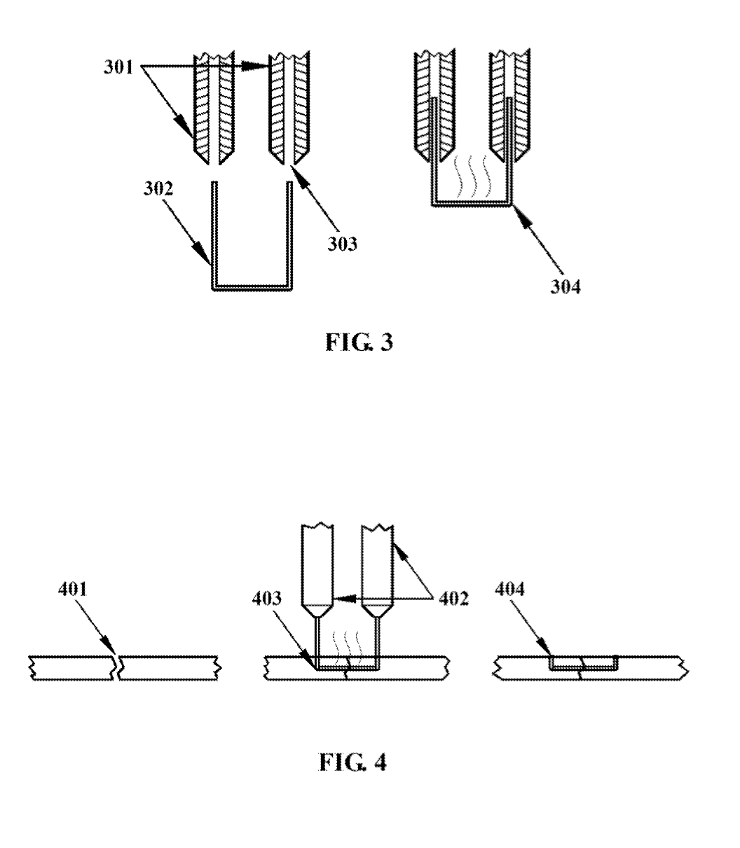

FIG. 3 is a cross sectional view of the universal stake adapter's stake retaining electrodes 301 which include a bore 303 within the electrode dimensioned to removably receive a stake 302. With the stake 302 inserted into the stake retaining electrodes 301 electrical current is conducted through the stake 302, causing the smaller diameter stake preferably 24 gauge to become a heated element 304.

FIG. 4 is a cross sectional view of the damaged thermoplastic material repair process. Damaged thermoplastic materials 401 are stitched together by activating the stud welder which conducts current through the universal stake adapter's electrodes 402 heating the stake 403 then pressing a heated stake 404 partially into the damaged area then deactivating the stud welder's power and allowing the stake to cool within the thermoplastic material. Caution and expertise is required not to overheat the small metal stake beyond 300 degrees Fahrenheit possibly burning the thermoplastic material. Once the stake cools, the universal stake adapter is removed, leaving the stake permanently imbedded within the thermoplastic material. Typically the excess stake material is removed 404.

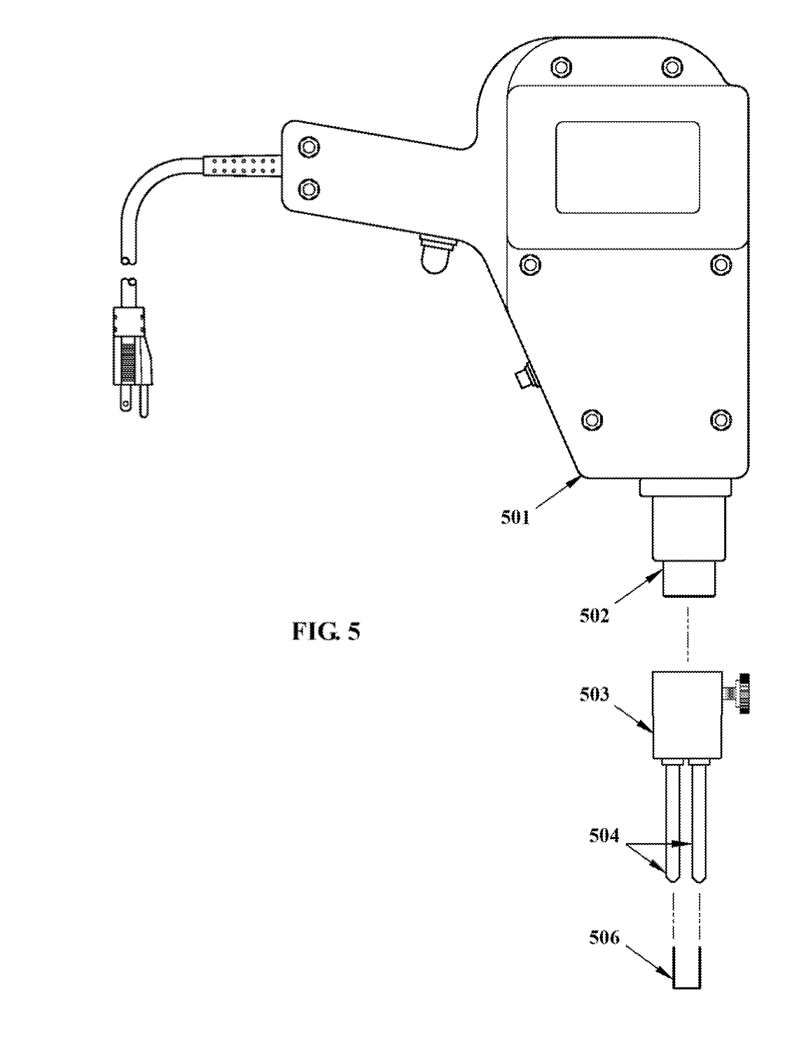

FIG. 5 is an exploded assembly view of the new universal stake thermoplastic repair tool in which the stud welder 501 which includes the power head 502 is converted into a Hot Stake Stitcher by connecting the universal stake adapter assembly 503 to the power head 502 and inserting a stake 506 into the stake retaining electrodes 504.

What is claimed is:

1. A Stake Adapter for a Dent Repair Stud Welder comprising:
(1) a outer electrode connected to a stake receiving electrode,
(2) a inner electrode connected to a stake receiving electrode.

2. The outer electrode of claim 1 is capable of providing electrical connection between said Dent Repair Stud Welder and a said stake receiving electrode.

3. The inner electrode of claim 1 is capable of providing electrical connection between said Dent Repair Stud Welder and a said stake receiving electrode.

4. Said stake receiving electrode of claim 1 wherein the stake receiving electrode includes a bore.

5. Said bore of claim 4 is dimensioned to removably receive a stake.

6. The Stake Adapter of claim 1 includes a means to attach to the Dent Repair Stud Welder of claim 1.

7. Said means of claim 6 is a screw.

8. A Stake Adapter for a Dent Repair Stud Welder which includes electrodes capable of providing electrical connections between a Dent Repair Stud Welder and stake receiving electrodes.

9. Said stake receiving electrodes of claim 8 wherein the stake receiving electrodes includes a bore.

10. Said stake receiving electrodes of claim 8 wherein said bore is dimensioned to receive a removable stake.

11. Said Stake Adapter of claim 8 includes a means to attach to the Dent Repair Stud Welder of claim 8.

12. Said means of claim 11 is a screw.

13. A Stake Adapter having a means of tapping electrical current from a Dent Repair Stud Welder and a means to transfer electrical current to a stake.

14. The said means of tapping electrical current of claim 13 include an inner electrode connected to inner electrode of the power head of a Dent Repair Stud Welder and an outer electrode connected to outer electrode of the power head of a Dent Repair Stud Welder.

15. The said means to transfer electrical current to a stake of claim 13 include an inner electrode connected to stake receiving electrode and an outer electrode connected to a stake receiving electrode.

16. Said stake receiving electrode of claim 15 wherein the stake receiving electrode includes a bore.

17. Said bore of claim 16 is dimensioned to receive a removable stake.

18. The said means to transfer electrical current to a stake of claim 13 include an inner electrode connected to said stake receiving electrode of claim 15 and an outer electrode connected to said stake receiving electrode of claim 15.
